(19) United States
(12) Patent Application Publication
(10) Pub. No.: US 2017/0199940 A1
(43) Pub. Date: Jul. 13, 2017

(54) DATA ENTRIES HAVING VALUES FOR FEATURES

(71) Applicants: Inbal TADESKI, Haifa (IL); Hadas KOGAN, Haifa (IL); Eli HAYOON, Haifa (IL); Eyal HAYUN, Haifa (IL); Doron SHAKED, Haifa (IL); Gil ELGRABLY, Haifa (IL); Olga SHAIN, Haifa (IL); HEWLETT PACKARD ENTERPRISE DEVELOPMENT LP, Houston, TX (US)

(72) Inventors: Inbal Tadeski, Yehud (IL); Hadas Kogan, Zichron Yaacov (IL); Eli Hayoon, Haifa (IL); Eyal Hayun, Haifa (IL); Doron Shaked, Haifa (IL); Gil Elgrably, Haifa (IL); Olga Shain, Haifa (IL)

(21) Appl. No.: 15/325,957

(22) PCT Filed: Oct. 30, 2014
(86) PCT No.: PCT/US2014/063218

§ 371 Date: Jan. 12, 2017

(51) Int. Cl. G06F 17/30; G06F 17/22; G06F 3/0482

(52) U.S. Cl. CPC G06F 17/30958; G06F 3/0482; G06F 17/2235; G06F 17/2264; G06F 17/2247; G06F 17/3053; G06F 17/30994

(57) ABSTRACT

Data entries can include values for each of a number of features that each have a number of permissible or possible values. The features and the permissible values thereof are ranked based on a graph constructed from the features and the permissible values. The data entries can include textual data for free-text features that do not have permissible values or possible values, and new features created based on information extracted from the textual data, where nodes and edges are added to the graph from these new features. Graphical elements corresponding to the features and graphical representations based on frequencies of the permissible values of the features can be displayed.

### BACKGROUND

Data is commonly presented in structured or semi-structured fashion. For instance, there may be a number of data entries making up the data. Each data entry may have values for a number of different features, or attributes. For some features, the values of each data entry may be restricted to a set of permissible or possible values. This type of data is structured data. For other features, the values of each data entry may not be so restricted. This type of data is semi-structured.

### BRIEF DESCRIPTION OF THE DRAWINGS

FIG. 1 is a flowchart of an example method for ranking and reranking structured data.

FIG. 2 is a flowchart of an example method for modifying semi-structured data so that this data can be used in the method of FIG. 1.

FIG. 3 is a diagram of example data including data entries having values for structured features and textual data for a freeform feature.

FIG. 4 is a diagram of an example graph corresponding to the example data of FIG. 3.

FIG. 5 is a diagram of the example data of FIG. 3, in which new features have been added that correspond to information items within the data entries for the freeform feature.

FIG. 6 is a diagram of the example graph of FIG. 4, in which new nodes and new edges have been added in correspondence with the example data of FIG. 5.

FIG. 7 is a flowchart of an example method for interactively displaying data ranked and reranked according to the method of FIG. 1 and/or FIG. 2.

FIG. 8 is a diagram of an example display of data that can be performed according to the method of FIG. 7.

FIG. 9 is a diagram of an example computing system in relation to which the methods of FIGS. 1, 2, and/or 7 can be implemented.

### DETAILED DESCRIPTION

As noted in the background, data can be semi-structured or structured. For example, consider survey data that may be generated by asking customers or other users a series of questions through an Internet web site. The questions may correspond to features, and the answers to the questions from the users may correspond to the data entries. Some questions may be answered by users selecting from a limited number of choices, such as a rating from 1-5, and so on. Other questions may be answered by users typing in freeform text, such to provide comments, and so on.

Collecting such survey data is useful to determine, for instance, how satisfied customers are with the products or services of a company. However, gleaning insights from survey data can be difficult to achieve, particularly when different personnel of the company may be interested in gleaning different types of insights. This issue is exacerbated when the survey data is semi-structured.

Techniques disclosed herein ameliorate these difficulties. An innovative approach by which structured data can be ranked, and reranked pursuant to user interaction, is provided, so that insights into the data can be gleaned. Another innovative approach is provided by which semi-structured data can be transformed into structured data, so that it can be ranked along with the originally structured data, for instance. A third innovative approach is provided to display an interactive graphical user interface (GUI) to present such rankings and permit the user to select data of interest to view rerankings based on the selected data.

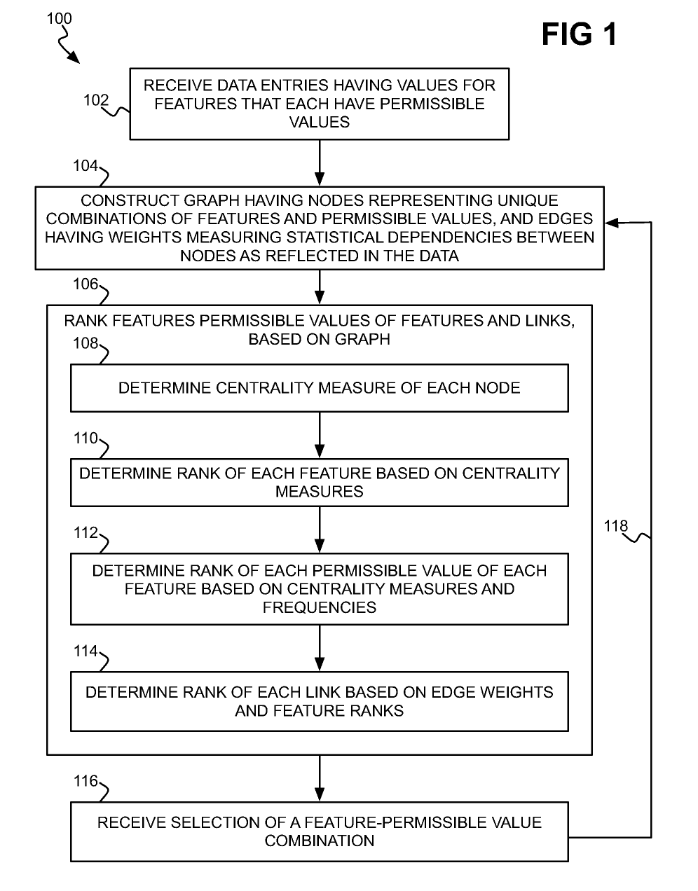

FIG. 1 shows an example method 100 for ranking and reranking structured data. The method 100 is performed by a processor of a computing device, such as a computer. The method 100 can be implemented as program code stored on a non-transitory computer-readable medium for execution by such a processor. The method 100 includes receiving data entries that have values for features (102). Each feature has a number, or set, of permissible values, which can also be referred to as possible values. Each data entry has a value for a feature that is selected from one of these permissible or possible values.

As one example, data entries may correspond to different users answering a survey. The survey has questions, which correspond to features, made up of questions. For a given question, a user may be permitted to select from a limited number of choices, such as a rating between 1 and 5, and so on. The limited number of choices are thus the permissible values for the feature in question. Each data entry, in other words, has a value for the feature, but the value has to be one of the permissible values for the feature.

In one implementation, a numerical feature can be processed as part of part 102 so that the feature has such a set of permissible values. For instance, the data entries may have a large number of different numerical values, and indeed which each may be unique. To limit the number of permissible values for the feature, the numerical values of the entries for this feature may be quantized and transformed to categorical data. For example, if the data entries have numerical values between one and one hundred for a feature, rather than having up to one-hundred permissible values for the feature, the numerical values may be quantized and transformed to a more limited number of ten permissible values, corresponding to ranges such as 1-10, 11-20, 21-30, and so on, through 91-100. Different such quantization and transformation approaches can be employed if this is desired.

The method 100 includes constructing a graph (104). The graph has nodes representing unique combinations of features and their permissible values. For example, if feature A has permissible values aa, ab, and ac, and feature B has permissible values ba, bb, bc, and bd, there are unique feature-permissible value combinations Aaa, Aab, Aac, Bba, Bbb, Bbc, and Bbd. Therefore, in this simplified example, there are a total of seven nodes within the graph.

The graph further has edges. Each edge connects two nodes. Each edge has a weight that measures the statistical dependency between the two nodes to which it connects, as reflected within the data (i.e., within the data entries). The statistical dependency of an edge can be defined as denoting how dependent the two nodes that the edge connects are to one another, in a statistical manner. This statistical dependency can be more particularly defined in one implementation as the normalized pairwise mutual information (NPMI) between the two (permissible) values of the two connected nodes. The NPMI between every unique pair of nodes in the graph is determined, but edges are created within the graph just for those unique node pairs that have NPMIs above a predetermined threshold.

For example, consider the two nodes Aaa and Bba. The NPMI(Aaa,Bba) is defined as:

$$NPMI ( Aaa , Bba ) = \frac{1}{H ( A ) + H ( B )} log \frac{p ( a , b )}{p ( a ) p ( b )} .$$

In this equation, H(X) measures the entropy of a feature X having values x within the data entries, and can be expressed as:

$$H ( X ) = - {\sum }_{x ∈ X}^{ } p ( x ) log p ( x ) .$$

In each of these two equations, p(x) is the frequency of permissible value x of feature X within the data entries, and p(x,y) is the frequency of the pair of permissible values x, y of features X, Y, respectively, within the entries.

The method 100 includes ranking the features, the permissible values of the features, and links, based on the graph (106). A link is defined as follows. For a given permissible value of a given feature, the links include the unique combinations of other features and the permissible values of these other features. For example, if feature A has permissible values aa, ab, and ac; feature B has permissible values ba, bb, bc, and bd; and feature C has permissible values ca and cb, then the links for the permissible value ba of feature B are Aaa, Aab, Aac, Cca, and Ccb.

In one example implementation, the features, permissible values thereof, and links of the permissible values are ranked as follows. A centrality measure of each node in the graph is determined (108). The centrality measure of a given node is based on the edges that extend from the node that have the highest K weights. For example, K may be three, such that the centrality measure of each node is based on the edges extending therefrom that have the highest three weights. If a particular node has less than K edges extending therefrom, then each edge is selected. The centrality measure of node i having edges j can be expressed as:

$${C}_{i} = {\sum }_{j ∈ top K}^{ } {W}_{i , j}$$

In this equation, Cᵢ is the centrality measure of node i, W_{i,j} is the weight of edge j extending from node i, and the summation is over the edges j having the highest weights.

A rank of each feature is determined based on at least the centrality measures of the nodes representing unique combinations that include the feature (viz., the nodes that include the feature) (110). In one example implementation, the ranking of a feature depends on the graph-based centrality measure of the feature, and an intrinsic measure that depends on the feature's entropy and the cluster size the feature represents. For example, the ranking of a feature can be expressed as:

$$rank {F}_{I} = {( H ( {F}_{I} ) * clusSize ( {F}_{I} ) )}^{α} * {( {\sum }_{i ∈ {F}_{I}}^{ } {P}_{i} {C}_{i} )}^{β} .$$

In this equation, rankFₗ is the ranking of feature Fₗ. The first term, (•)^{α}, relates to the intrinsic measure of this feature, and the latter term, (•)^{β}, relates to the graph-based centrality measure.

Furthermore, H(X) measures the entropy of feature X as noted above, and clusSize(Fₗ) is the size of the cluster that includes this feature. For instance, a feature may represent a column that is similar to other columns of the data and were removed. As an example, one column may represent customer name, which is similar to another column that represents customer code. A feature that corresponds to the customer name can represent a cluster that includes the customer name and the customer code. The size of this cluster is thus taken into account in the ranking.

Furthermore, Cᵢ is the centrality measure of node i as noted above, and Pᵢ is the frequency of the value represented by node i within the data entries. The constants α and β are selected to balance between the intrinsic measure of a feature, and the graph-based centrality measure of the feature, as desired. For an equal balancing, for instance, both may be equal to one.

A rank of each permissible value of each feature is determined based on the centrality measure of the node representing the unique combination of the permissible value in question and the feature in question, and based on the frequency of this permissible value of this feature within the data entries (112). For instance, the rank of a permissible value of a feature can be expressed as:

rankVᵢ=PᵢCᵢ.

In this equation, rankVᵢ is the rank of the value of node i for the feature of node i, Cᵢ is the centrality measure of node i as noted above, and Pᵢ is the frequency of the value represented by node i within the data entries as noted above.

A rank of each link is determined based on the weight of the edge corresponding to the link and based on the rank of the destination feature of the link (114), such as by multiplying the edge's weight by the destination feature's rank. That is, as noted above, for a given permissible value of a given feature, the links include the unique combinations of other features and the permissible values of these other features. Thus, a given such link includes a unique combination of a feature and a permissible value, and its rank is determined based on the weight of edge leading to the node representing this unique combination from the node representing the unique combination of the given permissible value and the given feature, and based on the rank of the feature of the link. Stated another way, a node Aaa representing feature A and value aa has a link representing Bba representing feature B and value bb. The rank of this link is determined based on the weight of the edge from node Aaa to node Bb and based on the rank of feature B. Feature B is the feature of this link, and node Aa is the node having the link.

For example, the rank of a link can be expressed as:

ranklᵢⱼ=wᵢⱼ^{γ}*rankF_{l,j∈l}.

In this equation, ranklᵢⱼ is the rank of link l from node i to node j, where node i is the node having the link, and node j is the node representing the unique combination of a value and a feature of the link. Furthermore wᵢⱼ is the weight of the link between these two nodes, γ is a constant that is selected to the balance the weight of the edge and the rank of the destination feature, as desired, and rankFₗ is the ranking of feature Fₗ, where feature j of the node j is ∈ l.

The initial ranking of the features, the permissible values, and the links can be subsequently modified responsive to a selection of a particular unique combination of a feature and a permissible value thereof (116). For example, a user may select a link in accordance with an interactive GUI, as is described in detail later in the detailed description. The features, the permissible values of each features, and the links for each permissible value of each feature are then reranked after construction of a sub-graph per the arrow 118. Stated another way, the reranking is performed based on a propagation of the graph from the node corresponding to the selected combination.

More specifically, graph propagation begins from the node corresponding to the selected combination to determine which features are most relevant, such as the most relevant K features. Data entries that include the selected combination, and which further include the most relevant features, are extracted, and a subgraph representing this subset of data entries is constructed. The subgraph and the originally constructed graph are employed to perform the reranking. The features and the permissible values are ranked by scores assigned from the propagation. The links are ranked so that high ranks are assigned to links that received higher ranks in the subgraph as compared to in the original graph.

Mathematically, a specific value U is selected that maps to node (Fₗ,U) with condition Fₗ=U. The centrality measure Cᵢ of each node I is determined by a graph propagation from the node U, and the ranks of the features and the permissible values thereof are updated by determining them as described above, but with the node centrality measures for the nodes. The data entries that satisfy the condition are extracted, and new weights wᵢⱼ^{u} determined. The ranks for the links are then determined as:

$${rankI}_{ij} = \frac{{w}_{ij}^{u}}{{w}_{ij} + const} .$$

In this equation, wᵢⱼ is the weight of the edge in question in the original graph, whereas wᵢⱼ^{u} is the weight in the new subgraph. Furthermore, const is a constant that is selected to suppress noise resulting from large ratios that may occur for very low values.

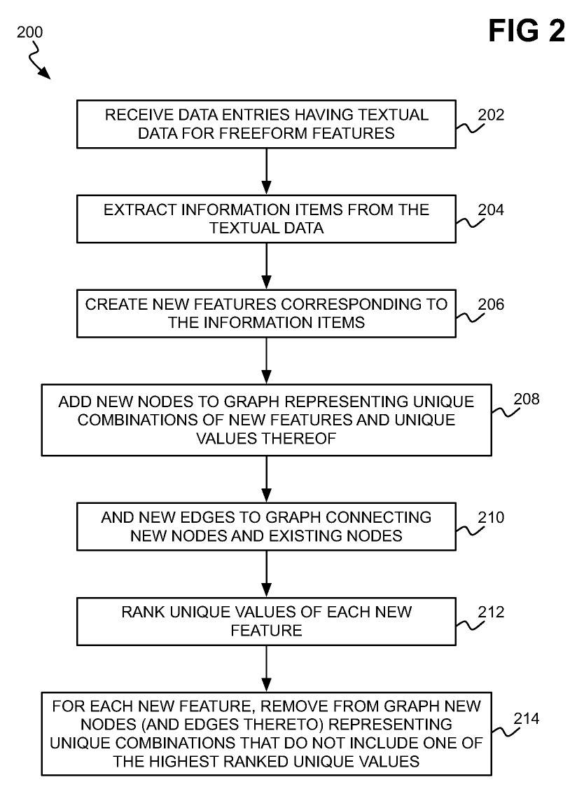

FIG. 2 shows an example method 200 for modifying semi-structured data so that such data can also be included in the method 100 of FIG. 1 that has been described. The method 200 can be performed, for instance, between parts 104 and 106 of the method 100. Like the method 100, the method 200 is performed by a processor of a computing device, and can be implemented as program code stored on a non-transitory computer-readable medium for execution by such a processor. The method 200 includes receiving data entries having textual data for freeform features (202).

The data entries may be the same of those in relation to which the method 100 has been described, but that also include freeform features in addition to the features that have sets of permissible values. Unlike the latter features, freeform features do not have sets of permissible values from which the textual data is selected. An example of a feature that has a set of permissible values is a state feature, which may have as its set of permissible values the fifty United States, the District of Columbia, and various US territories. An example of a freeform feature, by comparison, is a comments feature, where in the context of a survey respondents may enter in text to answer a question such as “what are the things preventing you from recommending a given product.”

The method 200 includes extracting information items from the textual data (204). Information items are types of different text, such as terms, named entities like companies and people, and topics. The information items are thus an abstraction of various words or phrases within the textual data of the entries. For example, various data entries may include the names of cities for a freeform feature, like Detroit, Chicago, Los Angeles, Seattle, New York City, and so on. The information item corresponding to or encompassing this textual data is cities, which is the type of this text or an abstraction of this text.

Existing techniques and tools can be employed to extract information items from the textual data of the entries. Such techniques and tools in general perform textual analysis to identify words and phrases within textual data, like that of the data entries, and identify commonalities among these words and phrases, such as information items.

The method 200 includes creating new features for the information items (206). For example, the original free-text feature for which the data entries have textual data may be called “comments.” Two information items, “companies” and “cities,” may have been extracted from the textual data. Therefore, two new features are created, “comments:companies” and “comments:cities.”

The data entries have values for these new features, corresponding to the textual data thereof that is encompassed by the corresponding information items. For example, if a data entry has the term “General Motors” for the freeform feature “comments,” then the data entry has the value “General Motors” for the new feature “comments:companies.” Each new feature thus has a set of unique values, where each unique value is present in at least one data entry. That is, each unique value of each new feature is present in the textual data for a freeform feature in at least one data entry. In some implementations, though, there can be thresholds so that rare words—i.e., words that appear in a relatively small number of data entries—are removed and not considered.

The method 200 includes adding new nodes to the graph that was constructed in part 104 of the method 100 (208). Each new node represents a unique combination of a new feature and a unique value thereof. Similarly, the method 200 includes adding new edges to the graph (210). Each new edge connects a new one to an existing node of the graph as constructed in part 104 of the method 100. As in part 104 of the method 100, the new edges have weights that measure the statistical dependencies between the nodes as reflected in the data entries, as has been described above.

In some situations, parts 208 and 210 may result in a large number of new nodes and new edges being added to the graph. Therefore, the least relevant new nodes, and the new edges that connect to them, may be subsequently removed from the graph to make analysis more tractable. In this respect, the method 200 can include ranking the unique values of each new feature (214), as in parts 108, 110, and/or 112 of the method 100, where the unique values of a new feature correspond to the permissible values thereof. The method 200 then, for each new feature, removes from the graph the nodes (and their edges) that do not include one of the highest ranked unique values (214).

For example, a new feature may have a large number of unique values, numbering in the tens, hundreds, or even more. An equal number of new nodes are added for this new feature in part 208, with likely an even greater number of new edges added in part 210. In part 212, the unique values of the new feature are ranked. In part 214, just the highest ranked new nodes for the new feature and the edges connecting to these new nodes are retained. The other new nodes, and their connecting edges, are removed. For instance, just the new nodes corresponding to the highest K=3 unique values for the new feature, and their edges, may be retained.

When the method 200 is finished, the remainder of the method 100 can continue, beginning at part 106. As described in relation to the method 100, structured features have sets of permissible values. As described in relation to the method 200, new features created from freeform features have sets of unique values. The unique values of the new features may be considered as the permissible values of the new features. Stated another way, the permissible values of the structured features are the possible values of the structured features, and likewise the unique values of the new features are the possible values of the new features.

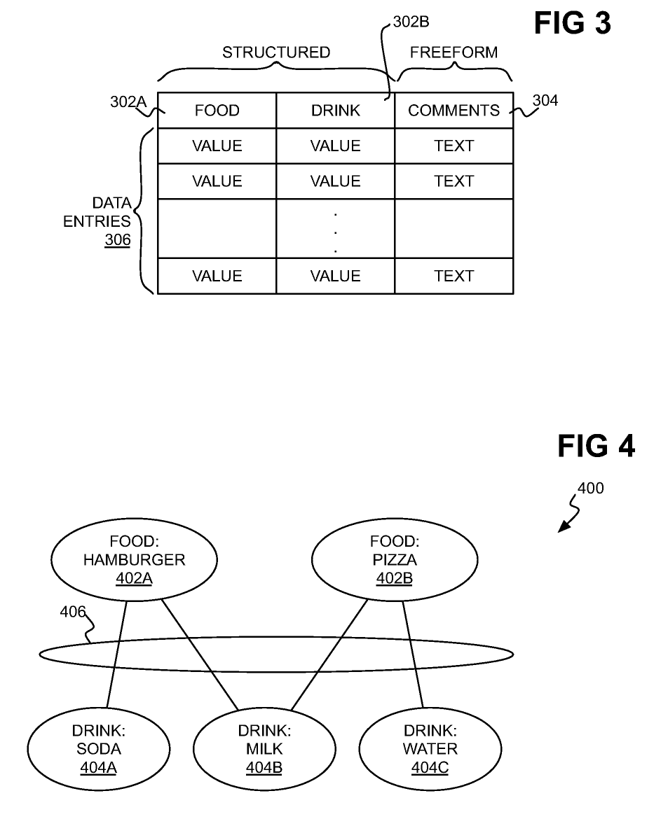

As a concrete if rudimentary example of the performance of the graph construction in particular of the methods 100 and 200, reference is now made to FIGS. 3, 4, 5, and 6. FIG. 3 shows example data in relation to which the methods 100 and 200 are performed. There are structured features 302A and 302B corresponding to “food” and “drink.” For example, the feature 302A may have the set of permissible values “hamburger” and “pizza,” whereas the feature 302B may have the set of permissible values “soda,” “milk,” and “water.” There is a freeform feature 304 corresponding to “comments” as well, which has no set of permissible values.

Data entries 306 include values for each structured feature 302A and 3026, and textual data for the freeform feature 304. The value for each structured feature 302A and 302B of each data entry 306 is selected from the set of permissible values of that feature. For example, one data entry may have the values “hamburger” and “milk” for the features 302A and 302B, respectively, whereas another data entry may have the values “pizza” and “milk.” The textual data for the freeform feature 304 of each data entry 306 is not so limited by comparison, and can include any type of text.

FIG. 4 shows an example initially constructed graph 400 for the example data of FIG. 3. The graph 400 is constructed pursuant to the method 100, and considers the structured features 302A and 302B and the values therefor within the data entries 306, but not the freeform feature 304 and the textual data therefor within the data entries 306. There are thus nodes 402A and 402B, referred to as the nodes 402 corresponding to the unique feature-value combinations for the feature “food,” and nodes 404A, 404B, and 404C, referred to as the nodes 404 corresponding to the unique feature-value combinations for the feature “drink.” There are also weighted edges 406 interconnecting the nodes 404 and the nodes 406.

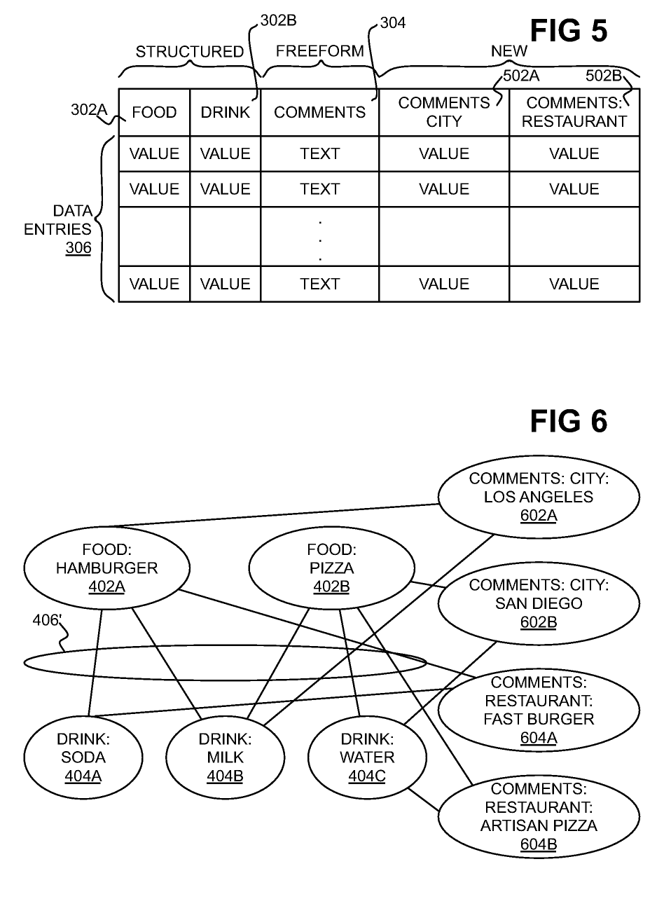

FIG. 5 shows the example data of FIG. 3 after the method 200 has been performed, in which new features have been added. As in FIG. 3, there are the structured features 302A and 302B for which the data entries 306 have values, and the freeform feature 304 for which the data entries 306 have textual data. During performance of the method 200, two new features 502A and 502B, collectively referred to as the new features 502, are created. The new features 502 correspond to information items extracted from the textual data of the data entries 306 for the freeform feature 304.

In the example of FIG. 5, the new feature 502A is “comments:city” and the new feature 502B is “comments:restaurant.” Over all the data entries 306, there may, for example, be three different cities within the textual data of the freeform feature 304: “Los Angeles,” “San Diego,” and “Palm Springs,” which are thus the unique values of the new feature 502A. Each of at least some of the data entries 306 has one of these values for the new feature 502A. Over all the data entries 306, there may be two different restaurant names within the textual data of the freeform feature 304: “Fast Burger” and “Artisan Pizza,” which are thus the unique values of the new feature 502B. Each of at least some of the data entries 306 has one of these values for the new feature 502B.

FIG. 6 shows an example graph 400′, which is the graph 400 of FIG. 4 with the additions thereto pursuant to the method 200. The graph 400′ includes the nodes 402 and 404 as before, and thus considers the structured features 302A and 302B and the values therefor within the data entries 306. However, the graph 400′ also considers the new features 502 and the values therefor within the data entries 306.

There are thus new nodes 602A and 602B, referred to as the new nodes 602. The node 602A corresponds to the unique combination of the value “Los Angeles” and the new feature “comments:city,” and the node 602B corresponds to the unique combination of the value “San Diego” and this same new feature. Note that there is no node within the graph 400′ corresponding to the unique combination of the value “Palm Springs” and the new feature “comments:city.” This may be because the node for this unique feature-value combination was removed in part 214; that is, part 214 may have considered just the two highest ranked unique values for the new feature “comments:city.”

There are also new nodes 604A and 604B, referred to as the new nodes 604. The node 604A corresponds to the unique combination of the value “Fast Burger” and the new feature “comments:restaurant,” and the node 604B corresponds to the unique combination of the value “Artisan Pizza” and this same new feature. The graph 400′ further includes edges 406′, which are the edges 406 of the graph 400 of FIG. 4, with the addition of new edges between the existing nodes 402 and 404 and the new nodes 602 and 604.

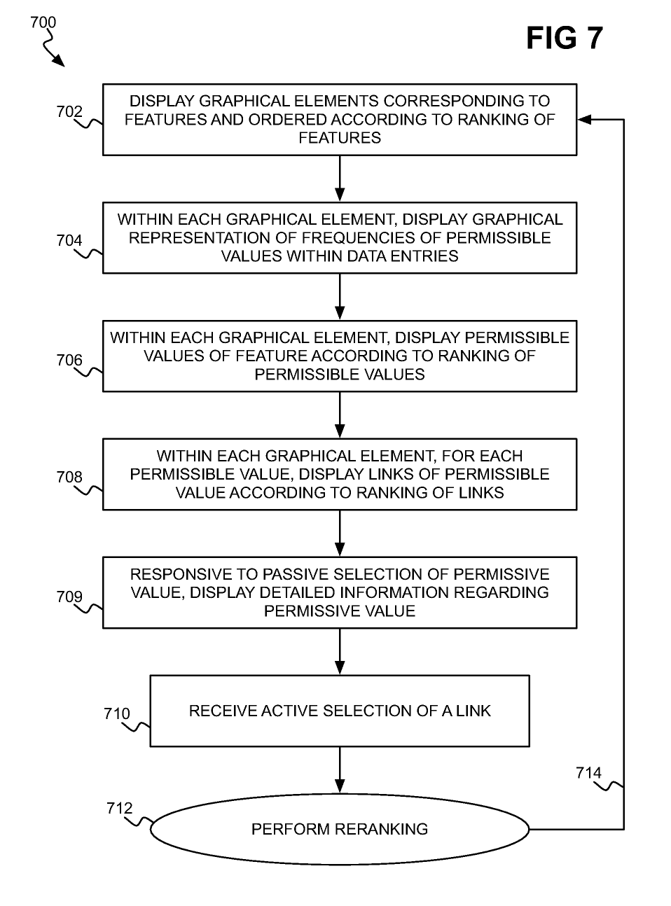

FIG. 7 shows an example method 700 for interactively displaying data that has been ranked according to the method 100 and/or the method 200. Parts 702, 704, 706, and 708 of the method 700 can be performed after part 106 of the method 100, for instance. Part 710 of the method 700 can be performed as part 116 of the method 100, and part 712 represents a reperformance of parts 104 and/or 106 of the method 100 as indicated by the arrow 118 in the method 100. Like the methods 100 and 200, the method 700 is performed by a processor of a computing device, and can be implemented as program code stored on a non-transitory computer-readable medium for execution by such a processor.

Graphical elements corresponding to the features, including the structured features and the new features that have been described, are displayed, in an order corresponding to the ranking of the features (702). Within each graphical element, a graphical representation of the frequencies of the corresponding feature's permissible values within the data entries is displayed (704), and the permissible values are also displayed in an order corresponding to the ranking of the permissible values (706). Furthermore, within each graphical element, for each permissible value of the corresponding feature, the links for the permissible value are displayed according to the ranking of the links (708).

Dynamic interaction with the data display can be achieved in at least two different ways. First, the method 700 can include receiving passive selection of a permissive value of a feature, responsive to which detailed information regarding the permissive value is displayed (709). For example, the detailed information can include detailed information regarding the presence of the passively selected value within the data entries. Passive selection may be achieved, for instance, a user navigating a pointer to a desired permissive value and hovering the pointer thereover within a GUI in relation to which the graphical elements have been displayed, which is known as “mouseover.”

Second, the method 700 can include receiving an active selection of one of the links that have been displayed (710), which corresponds to the receiving of a selection of a feature-permissible value combination in part 116 of the method 100. For example, within a GUI in relation to which the graphical elements have been displayed, a user may navigate a pointer to a desired link and select this link, using an input device. As a result of the selected link, a reranking is performed (712), corresponding to arrow 118 of the method 100, and the new reranked data is then displayed, per the arrow 714. In this way, the display and redisplay of data is achieved in an interactive manner. A user is able to focus in on the data of interest as desired, to glean insights into the data that may differ for different users.

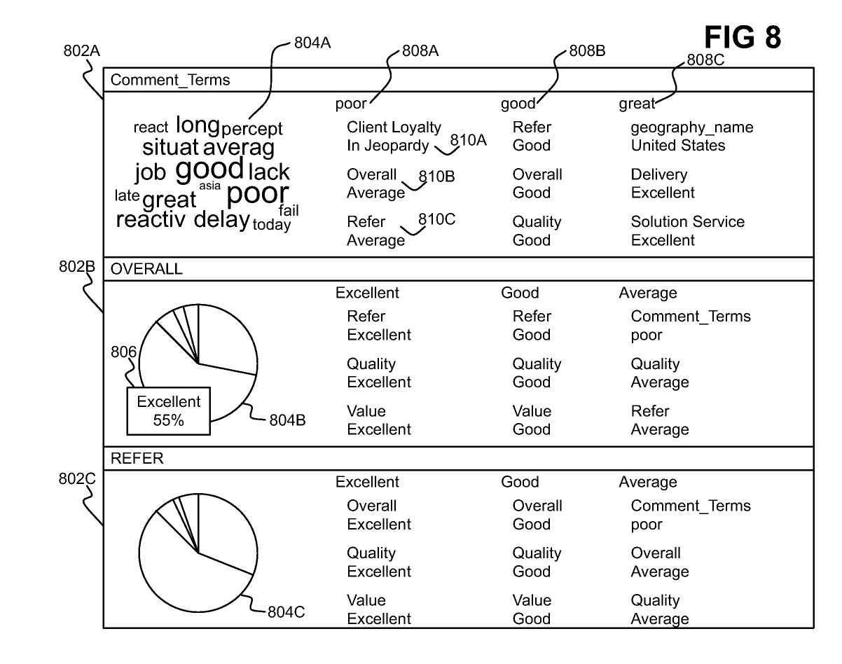

FIG. 8 shows an example data display provided by the method 700. Graphical elements 802A, 802B, and 802C, collectively referred to as the graphical elements 802, are displayed. The graphical elements 802 correspond to the features “Comment_Terms,” “Overall,” and “Refer.” The feature “Comment_Terms” has a highest ranking, and the feature “Refer” has a lowest ranking of these three features, such that the graphical element 802A is displayed on the top, and the graphical element 802B is displayed on the bottom. Graphical elements 802 for even lower-ranked features may be displayed via a user performing a scrolling down GUI action within the data display.

The graphical elements 802A, 802B, and 802C include graphical representations 804A, 804B, and 804C, respectively. The graphical representations 804 are collectively referred to as the graphical representations 804. The graphical representations 804 are of the frequencies of the permissible values within the data entries of the corresponding features.

The graphical representation 804A is a “word cloud” graphical representation of the unique values of the new feature of the graphical element 802A that may have been created according to the method 200. Each word of the graphical representation 804A is one of the unique values of this feature. Each word has a size within the graphical representation 804A corresponding to its frequency within the data entries (i.e., the number of data entries in which the word is present).

The graphical representations 804B and 804C are pie chart graphical representations of the permissible values of the structured features of the graphical elements 802B and 802C, respectively. Each slice corresponds to a permissible value of a structured feature. The size of each slice corresponds to its permissible value's frequency within the data entries (i.e., the number of data entries having the permissible value for the feature in question).

To glean more specific information regarding the permissible values displayed within the graphical representations 804, a user may passively select a word in the representation 804A or a slice in the representation 804B or 804C. A small text box may then be displayed near the passively selected permissible value that provides detailed information regarding the presence of this permissible value within the data entries, such as the percentage of the data entries that include this value for the feature in question. As an example, a text box 806 is displayed in FIG. 8 in correspondence with passive selection of the largest pie slice of the graphical representation 804B. The text box 806 identifies the permissible value to which the pie slice corresponds, and the percentage of the data entries that include this value for the feature in question. The text box 806 can be referred to as a “tooltip.”

For the remainder of the description of FIG. 8, the graphical element 802A is described as representative of each graphical element 802. Within the graphical element 802A, permissible values 808A, 808B, and 808C, which are collectively referred to as the permissible values 808, are displayed. The permissible values 808 are those of the feature to which the graphical element 802A corresponds. The permissible values 808 include “poor,” “good,” and “great.”

The permissible value 808A has a highest ranking, and the permissible value 808C has a lowest ranking of these three permissible values 808, such that the value 808A is displayed left most within the graphical element 802A, and the value 808C is displayed right-most. Even lower-ranked permissible values 808 for even lower-ranked features may be displayed via a user performing a scrolling right GUI action within the data display. The permissible values 808 may be color-coded in correspondence with their colors within the graphical representation 804A, which is particularly useful where a graphical representation is a pie chart, for instance.

For the remainder of the description of FIG. 8, the permissible value 808A is described as representative of each permissible value 808. Links 810A, 810B, and 810C, collectively referred to as the links 810, for the permissible value 808A are displayed. Each link 810 includes a unique combination of a feature and a permissible value for the feature. The links 810 thus include the combination of the feature “client loyalty” and the permissible value “in jeopardy” for the feature “client loyalty”; the combination of the feature “overall” and the permissible value “average” for the feature “overall”; and the combination of the feature “refer” and the permissible value “average” for the feature “refer.” The link 810A has a highest ranking, and the link 810C has a lowest rank of these three links 810, such that the link 810A is displayed above the link 810C. A user may select one of these links 810 to cause a reranking to be performed, and a display of the data in accordance with this reranking.

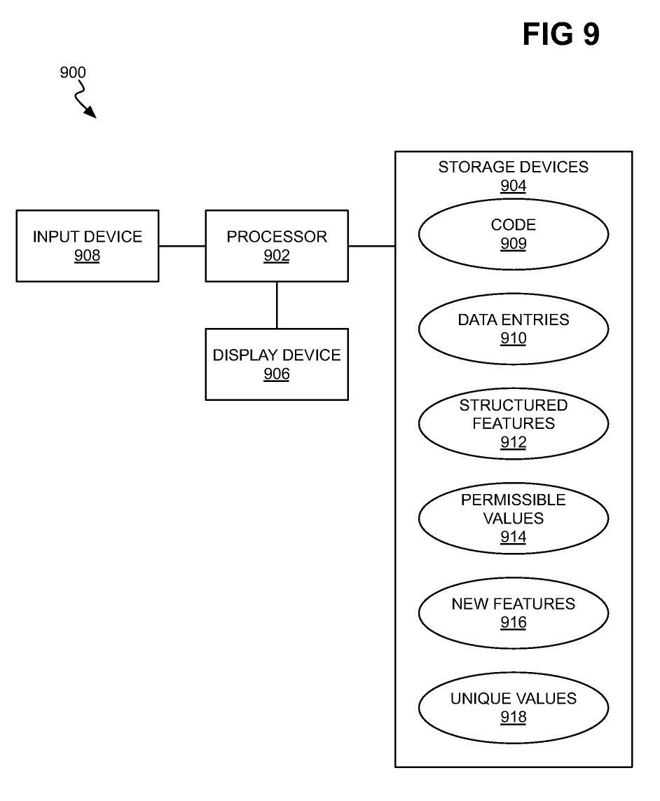

FIG. 9 shows an example computing system 900, like a computing device such as a computer. The system 900 can include a processor 902, storage devices 904, a display device 906, and an input device 908. The processor 902 may be a central processing unit (CPU) of a computing device. The storage devices 904 can include volatile and non-volatile storage devices, such as magnetic storage devices, semiconductor storage devices, optical storage devices, and so on. The display device 906 may be a flat-panel display, or another type of display device, in relation to which the method 700 is performed. The input device 908 may be a keyboard, a mouse, a touchpad, a touchscreen (and thus integrated with the display device 906), and/or another type of pointing device or other input device. The user input of the methods 100 and 700 can be performed via the input device 908.

The storage devices 904 store program code 909. The processor 902 executes the code 909 to perform the methods 100, 200, and 700 that have been described. It is noted, however, that the methods 100, 200, and 700 can instead be implemented just in hardware, such as via a field-programmable gate array (FPGA) device, an application-specific integrated circuit (ASIC) device, and so on. The storage devices 904 store the data entries 910, structured features 912, and permissible values 914 of the features 912, in relation to which the methods 100 and 700 are performed. The storage devices 904 further store new features 916 and unique values of the new features 918 that may be generated as a result of performance of the method 200.

We claim:

1. A method comprising:
for entries of data, each entry having a value for each of a plurality of features, each feature having a plurality of permissible values from which the values of the entries have been selected,
constructing, by a processor, a graph having nodes and edges, each node representing a unique combination of a feature and a permissible value of the feature, each edge connecting two nodes and having a weight measuring a statistical dependency between the two nodes as reflected in the data; and
ranking, by the processor, the features, the permissible values of each feature, and links for each permissible value of each feature, based on the graph,
wherein for each permissible value of each feature, the links comprise unique combinations of other features and the permissible values of the other features.

2. The method of claim 1, further comprising receiving, by the processor, the entries of data that each include a numerical value for a numerical feature, including quantizing and transforming the numerical values of the numerical value to a plurality of permissible values for the numerical value.

3. The method of claim 1, further comprising:
receiving, by the processor, selection of a particular unique combination of a feature and a permissible value of the feature; and
reranking, by the processor, the features, the permissible values of each feature, and the links for each permissible value of each feature, using a propagation of the graph from the node corresponding to the particular unique combination.

4. The method of claim 3, wherein reranking the features, the permissible values of each feature, and the links for each permissible value of each feature using the propagation of the graph includes selecting a subset of the values within the data entries and constructing a new graph from the selected subset.

5. The method of claim 1, wherein ranking the features, the permissible values of each feature, and the links for each permissible value of each feature, based on the graph, comprises:
for each node, determining a centrality measure based on one or more edges extending from the node having highest weights;
for each feature, determining a rank based on at least the centrality measures of the nodes representing the unique combinations that include the feature;
for each permissible value of each feature, determining a rank based on the centrality measure of the nodes representing the unique combination including the permissible value and the feature and based on a frequency of the permissible value within the entries; and
for each link, determining a rank based on the weight of the edge corresponding to the link and based on the rank of the other feature of the link.

6. The method of claim 1, wherein each entry has textual data for a free-text feature not having a plurality of permissible values from which the textual data is selected,
wherein the method further comprises:
extracting, by the processor, information items from the textual data of the entries; and
creating, by the processor, new features corresponding to the information items, each entry having a value for each new feature,
and wherein constructing the graph comprises:
adding nodes corresponding to unique combinations of the new features and unique values of the new features, for at least some of the unique combinations of the new features and the unique values of the new features.

7. The method of claim 1, further comprising:
displaying, by the processor, a plurality of graphical elements corresponding to the features and ordered according to a ranking of the features;
within each graphical element representing a feature, displaying, by the processor, a graphical representation of frequencies of the permissible values of the feature within the entries; and
within each graphical element representing a feature, displaying, by the processor:
the permissible values of the feature according to a ranking of the permissible values; and
for each permissible value of the feature, the links according to a ranking of the links.

8. The method of claim 1, wherein during graphical user interface (GUI) navigation of the features, the permissible values, and the links, the links provide a mechanism by which features that are related to one another are navigated and by which subsets of the data are selectively focused upon.

9. A non-transitory computer-readable data storage medium storing program code executable by a processor to:
for entries of data, each entry having textual data for a free-text feature not having a plurality of permissible values from which the textual data is selected,
extract information items from the textual data of the entries;
create new features corresponding to the information items, each entry having a value for each new feature;
add new nodes to a graph already having existing nodes and existing edges, each new node representing a unique combination of a new feature and a unique value of the new feature; and
add new edges to the graph, each new edge connecting a new node and an existing node and having a weight measuring a statistical dependency therebetween as reflected in the data.

10. The non-transitory computer-readable data storage medium of claim 9, wherein extracting the information items from the textual data of the entries comprises extracting named entities and terms.

11. The non-transitory computer-readable data storage medium of claim 9, wherein the program code is executable by the processor to further:
rank the unique values of each new feature; and
for each new feature, remove from the graph the new nodes representing the unique combinations of the new feature and each unique value thereof that is not one of the highest ranked unique values thereof.

12. The non-transitory computer-readable data storage medium of claim 9, wherein each entry further has a value for each of a plurality of existing features, and each existing feature having a plurality of permissible values from which the values of the entries have been selected,
wherein each existing node represents a unique combination of an existing feature and a permissible value of the existing feature, and each existing edge connects two existing nodes and having a weight measuring a statistical dependency between the two existing nodes as reflected in the data,
wherein features include the existing features and the new features, each feature has a plurality of possible values, the possible values of the existing features being the permissible values thereof, and the possible values of the new features being the unique values thereof, and
wherein the program code is executable by the processor to further:
rank the features, the possible values of each feature, and links for each possible value of each feature, based on the graph,
and wherein for each possible value of each feature, the links comprise unique combinations of other features and the possible values of the other features.

13. The non-transitory computer-readable data storage medium of claim 12, wherein the program executable is executable by the processor to further:
construct the graph having the existing nodes and the existing edges.

14. The non-transitory computer-readable data storage medium of claim 9, wherein each entry further has a value for each of a plurality of existing features, and each existing feature having a plurality of permissible values from which the values of the entries have been selected,
wherein each existing node represents a unique combination of an existing feature and a permissible value of the existing feature, and each existing edge connects two existing nodes and has a weight measuring a statistical dependency between the two existing nodes as reflected in the data,
wherein features include the existing features and the new features, each feature has a plurality of possible values, the possible values of the existing features being the permissible values thereof, and the possible values of the new features being the unique values thereof, and
wherein the program code is executable by the processor to further:
display a plurality of graphical elements corresponding to the features and ordered according to a ranking of the features;
within each graphical element representing a feature, display a graphical representation of frequencies of the possible values of the feature within the entries; and
within each graphical element representing a feature, display
the possible values of the feature according to a ranking of the possible values; and
for each possible value of the feature, links according to a ranking of the links,
wherein for each possible value of each feature, the links comprise unique combinations of other features and the possible values of the other features.

15. A system comprising:
a storage device storing a plurality of entries of data, each entry having a value for each of a plurality of features, each feature having a plurality of permissible values from which the values of the entries have been selected;
a display device;
a processor to:
display on the display device a plurality of graphical elements corresponding to the features and ordered according to a ranking of the features;
within each graphical element representing a feature, display on the display device a graphical representation of frequencies of the permissible values of the feature within the entries; and
within each graphical element representing a feature, display on the display device:
the permissible values of the feature according to a ranking of the permissible values; and
for each permissible value of the feature, links according to a ranking of the links,
wherein for each permissible value of each feature, the links comprise unique combinations of other features and the permissible values of the other features.

16. The system of claim 15, further comprising:
an input device,
wherein the processor is further to, responsive to an active selection of one of the links:
redisplay on the display device the graphical elements according to a reranking of the features based on the active selection;
within each graphical element representing a feature, display on the display device:
the permissible values of the feature according to a reranking of the permissible values based on the active selection; and
for each permissible value of the feature, the links according to a reranking of the links based on the active selection.

17. The system of claim 15, further comprising:
an input device,
wherein the processor is further to, responsive to a passive selection of a particular permissible value of a particular feature:
display detailed information regarding presence of the particular permissible within the entries.

18. The system of claim 15, wherein the processor is further to:
construct a graph having nodes and edges, each node representing a unique combination of a feature and a permissible value of the feature, each edge connecting two nodes and having a weight measuring a statistical dependency between the two nodes as reflected in the data; and
rank the features, the permissible values of each feature, and the links for each permissible value of each feature, based on the graph.

19. The system of claim 15, wherein each entry has textual data for a free-text feature not having a plurality of permissible values from which the textual data is selected, additional features correspond to information items extracted from the textual data of the entries, and each entry has a value for each additional feature.
